(19) United States
(12) Patent Application Publication
(10) Pub. No.: US 2016/0065945 A1
(43) Pub. Date: Mar. 3, 2016

(54) SYSTEMS, METHODS, AND MEDIA FOR GENERATING STRUCTURED LIGHT

(71) Applicant: THE TRUSTEES OF COLUMBIA UNIVERSITY IN THE CITY OF NEW YORK, New York, NY (US)

(72) Inventors: Qi YIN, New York, NY (US); Mohit GUPTA, New York, NY (US); Shree NAYAR, New York, NY (US)

(21) Appl. No.: 14/783,711

(22) PCT Filed: Apr. 14, 2014
(86) PCT No.: PCT/US2014/034000

§ 371 Date: Oct. 9, 2015

Related U.S. Application Data
(60) Provisional application No. 61/811,543, filed on Apr. 12, 2013.

(51) Int. Cl. H04N 13/02; G02B 26/12; G02B 26/10; G01B 11/25

(52) U.S. Cl. CPC H04N 13/0282; G01B 11/2518; G02B 26/122; G02B 26/105; G02B 26/127; H04N 13/0253

(57) ABSTRACT

Systems and methods for generating structured light are provided. In some embodiments, systems for generating structured light are provided, the systems comprising: a light source that produces light; a scanner that reflects the light onto a scene; and a hardware processor that controls a scanning speed of the scanner, wherein the scanning speed of the scanner is controlled to provide variable light distributions. In some embodiments, methods for generating structured light are provided, the methods comprising: producing light using a light source; reflecting the light onto a scene using a scanner; and controlling a scanning speed of the scanner using a hardware processor, wherein the scanning speed of the scanner is controlled to provide variable light distributions.

### CROSS REFERENCE TO RELATED APPLICATION

This application claims the benefit of U.S. Provisional Patent Application No. 61/811,543, filed Apr. 12, 2013, which is hereby incorporated by reference herein in its entirety.

### BACKGROUND

Systems for generating structured light for three-dimensional (3D) scanning are widely used for various purposes, such as factory automation for robotic assembly, visual inspection and autonomous vehicles. Illumination strategies in such structured-light-based systems have been developed for measuring and reconstructing the shape of objects in a scene under various settings.

In many real-world applications, structured light sources have to compete with strong ambient illumination. For instance, in outdoor settings, where sunlight is often brighter than the projected structured light, the signal in the captured images can be extremely low, resulting in poor 3D reconstructions.

The problem of real-world settings and outdoor brightness is compounded by the fact that merely increasing the power of the light source is not always possible. Especially in outdoor scenarios, vision systems operate on a limited power budget.

Accordingly, it is desirable to provide improved systems, methods, and media for generating structured light that can better handle diverse real-world settings and outdoor brightness.

### SUMMARY

Systems and methods for generating structured light are provided. In some embodiments, systems for generating structured light are provided, the systems comprising: a light source that produces light; a scanner that reflects the light onto a scene; and a hardware processor that controls a scanning speed of the scanner, wherein the scanning speed of the scanner is controlled to provide variable light distributions.

In some embodiments, methods for generating structured light are provided, the methods comprising: producing light using a light source; reflecting the light onto a scene using a scanner; and controlling a scanning speed of the scanner using a hardware processor, wherein the scanning speed of the scanner is controlled to provide variable light distributions.

### BRIEF DESCRIPTION OF THE DRAWINGS

FIG. 1 is a diagram of an example of hardware that can be used to generate structured light in accordance with some embodiments.

FIG. 2 is a block diagram of an example of computer hardware that can be used in accordance with some embodiments.

FIG. 3A is a diagram showing an example of laser light projector hardware that can be used in accordance with some embodiments.

FIGS. 3B, 3C, and 3D are diagrams of examples of illuminated scenes that can be generated using a laser light projector with high, moderate, and low polygonal mirror rotation speeds, respectively, in accordance with some embodiments.

FIG. 3E is an example of a graph showing different image intensities within the space of an illuminated area, in accordance with some embodiments.

FIGS. 4A, 4B, and 4C are diagrams of examples of different light distributions that can be used, in accordance with some embodiments.

FIG. 5 is a diagram of an example of a process that can provide 3D reconstruction by generating structured light, in accordance with some embodiments.

### DETAILED DESCRIPTION

Mechanisms, which can include systems, methods, and media, for generating structured light are provided.

In some embodiments, these mechanisms can project laser light onto a polygonal mirror rotating at various rotation speeds. The projected light can then be reflected by the surface of the polygonal mirror and subsequently projected as a light pattern onto objects that are part of a scene that is subject to a variety of ambient illumination levels. The intensity and distribution of the laser light patterns projected onto the scene can depend on the rotation speed of the polygonal mirror. In some embodiments, the projected laser light pattern can be a block of columns, in which each block has a block size. A light projection block size can be determined using the ambient illumination levels. The rotation speed of the mirror can then be controlled to achieve the determined block size using a controllable motor. After the projected blocks of light impact objects in the scene, the reflections of the projected blocks can be detected and stored as images by any suitable camera. The stored images can then be concatenated into a single image. This single image can then be projected by the projector during a single projection scan. A comparison between projector pixels and camera pixels can then determine a corresponding block containing a corresponding column for each pixel. Reconstruction of the scene can be performed by estimating the corresponding column using the decoding algorithm for the coding scheme used within each corresponding block.

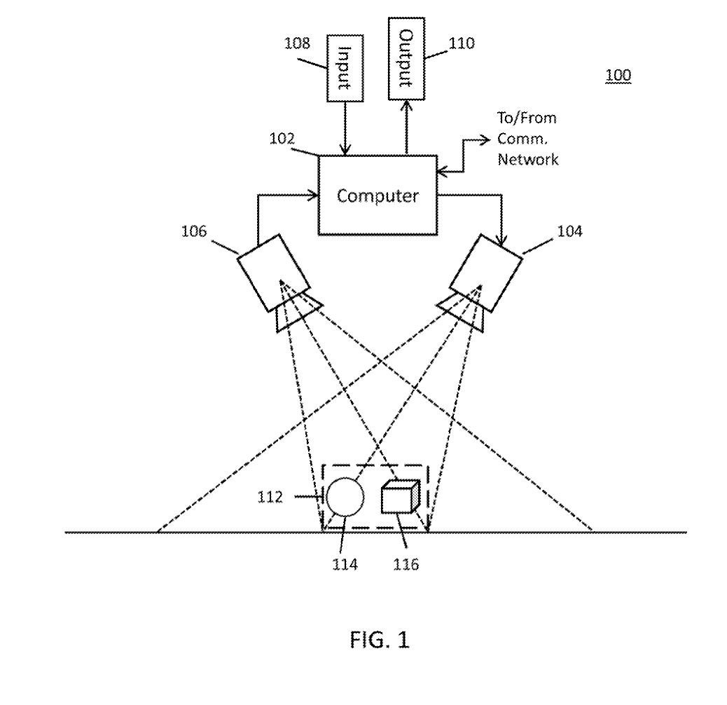

In FIG. 1, an example 100 of hardware that can be used in accordance with some embodiments is illustrated. As shown, hardware 100 can include a computer 102, a projector 104, a camera 106, one or more input devices 108, and one or more output devices 110 in some embodiments.

During operation, computer 102 can cause projector 104 to project any suitable number of structured light images onto a scene 112, which can include any suitable objects, such as objects 114 and 116, in some embodiments. At the same time, camera 106 can detect light reflecting from the scene and provide detected images to the computer in some embodiments. The computer can then perform processing as described herein to determine the reconstruction of the scene.

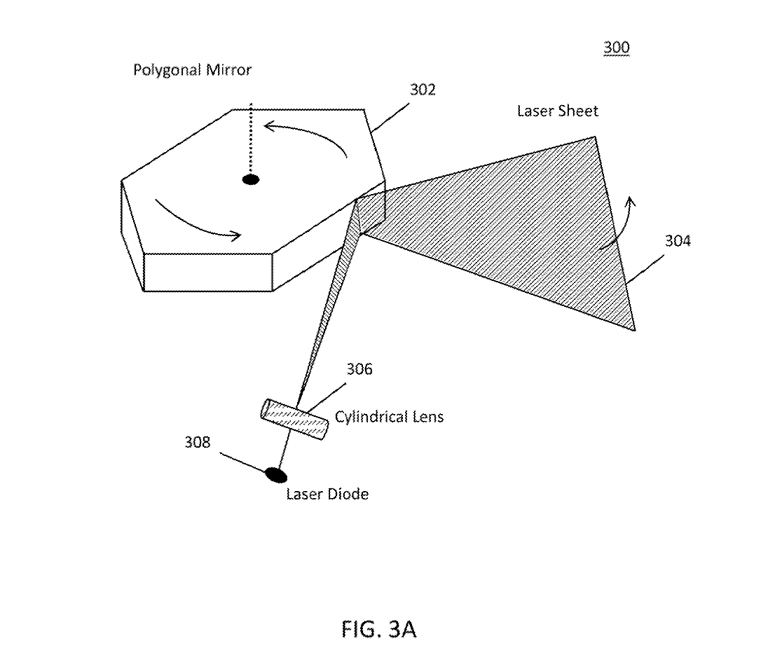

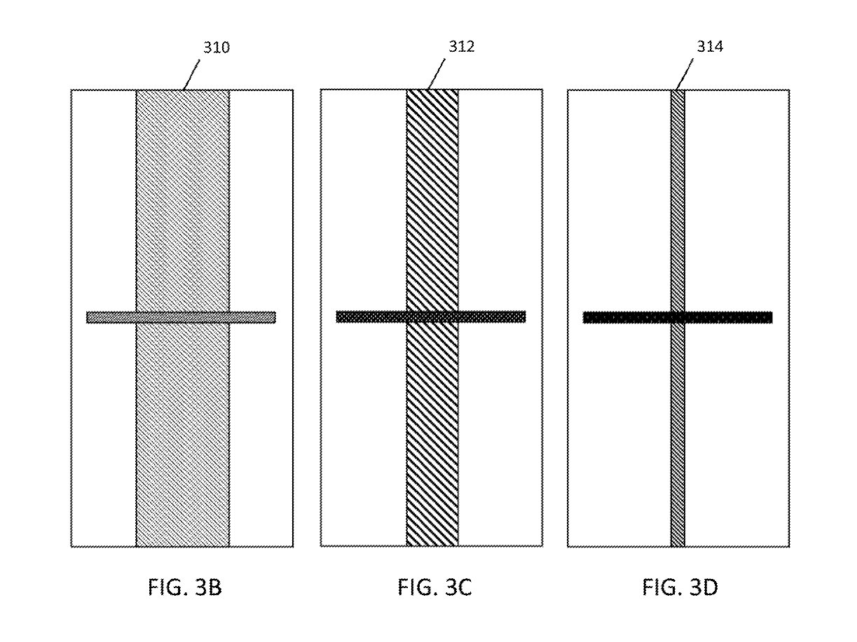

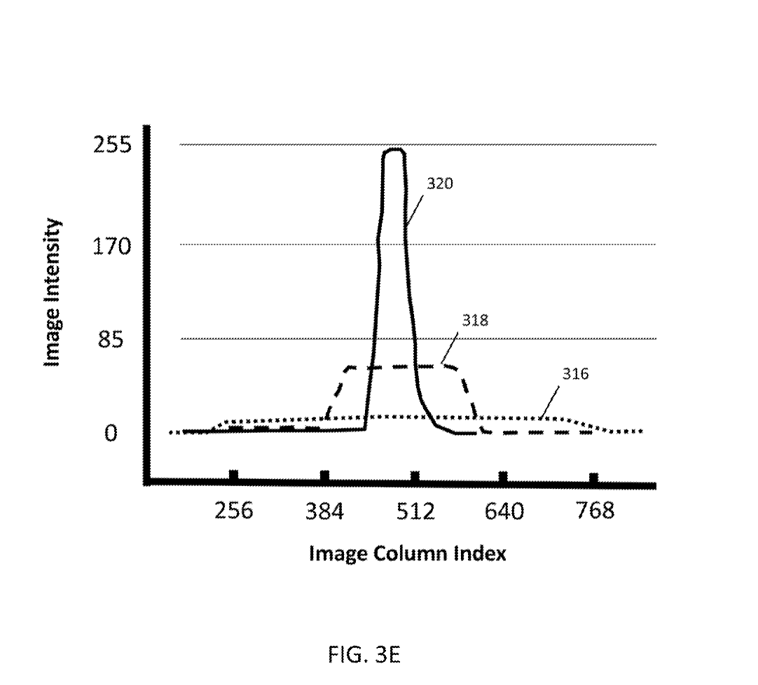

Projector 104 can be any suitable device for projecting structure light images as described herein. In some embodiments, projector 104 can be any suitable laser light projector such as a scanning projector that raster-scans a narrow beam of light rapidly across the image scene. A scanner projector can use any suitable light scanner to scan light. For example, in some embodiments, the scanner projector can be a polygonal scanner that uses a rotating polygonal mirror, such as the one shown in FIG. 3A, or can be a galvanometer that rotates multiple mirrors, to scan light. More particularly, for example, in some embodiments, projector 104 can be a scanning projector such as the SHOWWX+™ Laser Pocket Projector available from MicroVision, Inc. of, Redmond, Wash., or a projection system such as the Cartesia 3D Handy Scanner HS01 available from Spacevision, Inc. of Tokyo, Japan. In some embodiments, projector 104 can be a conventional projector that uses condenser lenses to condense light into concentrated regions

Input devices 108 can be any suitable one or more input devices for controlling computer 102 in some embodiments. For example, input devices 108 can include a touch screen, a computer mouse, a pointing device, one or more buttons, a keypad, a keyboard, a voice recognition circuit, a microphone, etc.

Output devices 110 can be any suitable one or more output devices for providing output from computer 102 in some embodiments. For example, output devices 110 can include a display, an audio device, etc.

Any other suitable components can be included in hardware 100 in accordance with some embodiments. Any suitable components illustrated in hardware 100 can be combined and/or omitted in some embodiments. For example, such hardware can include a laser light source (e.g., such as a laser diode), a controllable motor (e.g., such as a stepper motor), a polygonal mirror, a galvanometer, a cylindrical lens, speed control circuitry, and/or a hardware processor (such as in a computer).

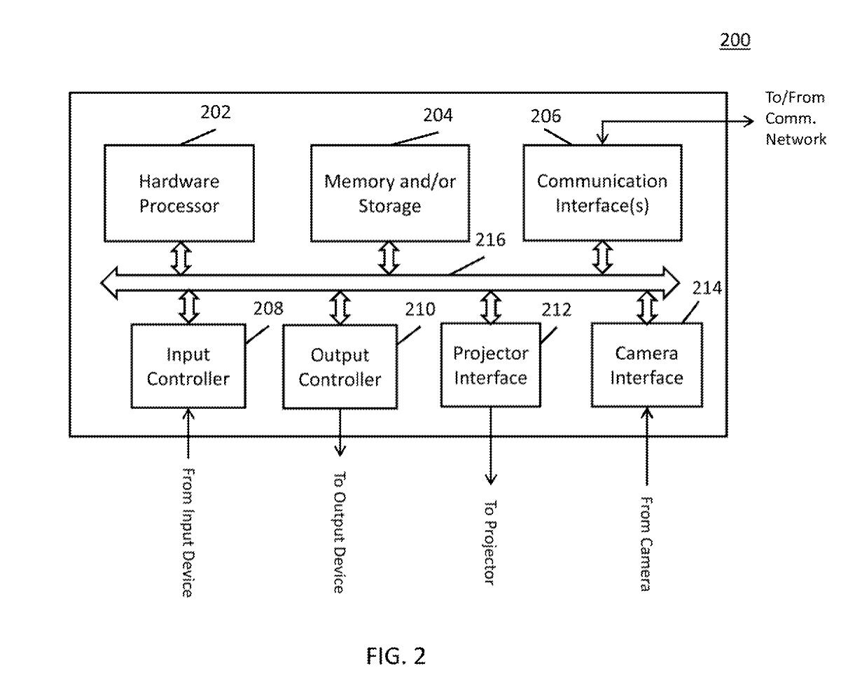

Computer 102 can be implemented using any suitable hardware in some embodiments. For example, in some embodiments, computer 102 can be implemented using any suitable general purpose computer or special purpose computer. Any such general purpose computer or special purpose computer can include any suitable hardware. For example, as illustrated in example hardware 200 of FIG. 2, such hardware can include a hardware processor 202, memory and/or storage 204, communication interface(s) 206, an input controller 208, an output controller 210, a projector interface 212, a camera interface 214, and a bus 216.

Hardware processor 202 can include any suitable hardware processor, such as a microprocessor, a micro-controller, digital signal processor, dedicated logic, and/or any other suitable circuitry for controlling the functioning of a general purpose computer or special purpose computer in some embodiments.

Memory and/or storage 204 can be any suitable memory and/or storage for storing programs, data, images to be projected, detected images, measurements, etc. in some embodiments. For example, memory and/or storage 204 can include random access memory, read only memory, flash memory, hard disk storage, optical media, etc.

Communication interface(s) 206 can be any suitable circuitry for interfacing with one or more communication networks in some embodiments. For example, interface(s) 206 can include network interface card circuitry, wireless communication circuitry, etc.

Input controller 208 can be any suitable circuitry for receiving input from one or more input devices 108 in some embodiments. For example, input controller 208 can be circuitry for receiving input from a touch screen, from a computer mouse, from a pointing device, from one or more buttons, from a keypad, from a keyboard, from a voice recognition circuit, from a microphone, etc.

Output controller 210 can be any suitable circuitry for controlling and driving one or more output devices 110 in some embodiments. For example, output controller 210 can be circuitry for driving output to a display, an audio device, etc.

Projector interface 212 can be any suitable interface for interfacing hardware 200 to a projector, such as projector 104, in some embodiments. Interface 212 can use any suitable protocol in some embodiments.

Camera interface 214 can be any suitable interface for interfacing hardware 200 to a camera, such as camera 106, in some embodiments. Interface 214 can use any suitable protocol in some embodiments.

Bus 216 can be any suitable mechanism for communicating between any combination of two or more of components 202, 204, 206, 208, 210, 212, and 214 in some embodiments.

Any other suitable components can be included in hardware 200 in accordance with some embodiments. Any suitable components illustrated in hardware 200 can be combined and/or omitted in some embodiments.

As shown in FIG. 3A, in accordance with some embodiments, a projector 104 can be a scanning projector that has a polygonal mirror 302 with a controllable rotation speed that is controlled by a motor (not shown) that can be controlled by hardware processor 202 in computer 102. In some embodiments, the light source can be laser diode 308 that projects light through cylindrical lens 306. Laser sheet 304 can be projected to the image scene causing different laser light patterns based on the sweeping motion of the polygonal mirror 302. The sweeping motion of the polygonal mirror can be controlled by its rotation speed that can cause the laser light patterns to be projected onto the image scene at different light distributions for different speeds.

For example, as shown in FIGS. 3B, 3C, and 3D, in some embodiments, as the rotation speed changes, both the illuminated area and the image intensity captured by camera 106 can change. More particularly, for example, as shown in FIG. 3B, a high rotation speed can cause a large illumination area 310, but a low image intensity, as shown in curve 316 in FIG. 3E. As shown in FIG. 3C, as the rotation speed decreases, the size of the illumination area can also decrease, as shown by medium illumination area 312, while the image intensity can increase, as shown in curve 318 in FIG. 3E. As shown in FIG. 3D, as the rotation speed is decreased even further, the illumination area can decrease to a single column 314 with a still higher image intensity as shown in curve 320 in FIG. 3E.

In FIG. 3E, an example of a relationship between the size of an illumination area, that can be measured as indicated by a number of columns in the x-axis, and an image intensity captured by camera 106 is shown for different rotation speeds of a polygonal mirror. For example, as shown by curve 316, a high rotation speed can cause a low image intensity that is spread through a large number of columns in the image scene. As the rotation speed decreases, the image intensity can increase, while the illumination area can decrease as indicated by the number of columns that are illuminated, as shown by curves 318 and 320.

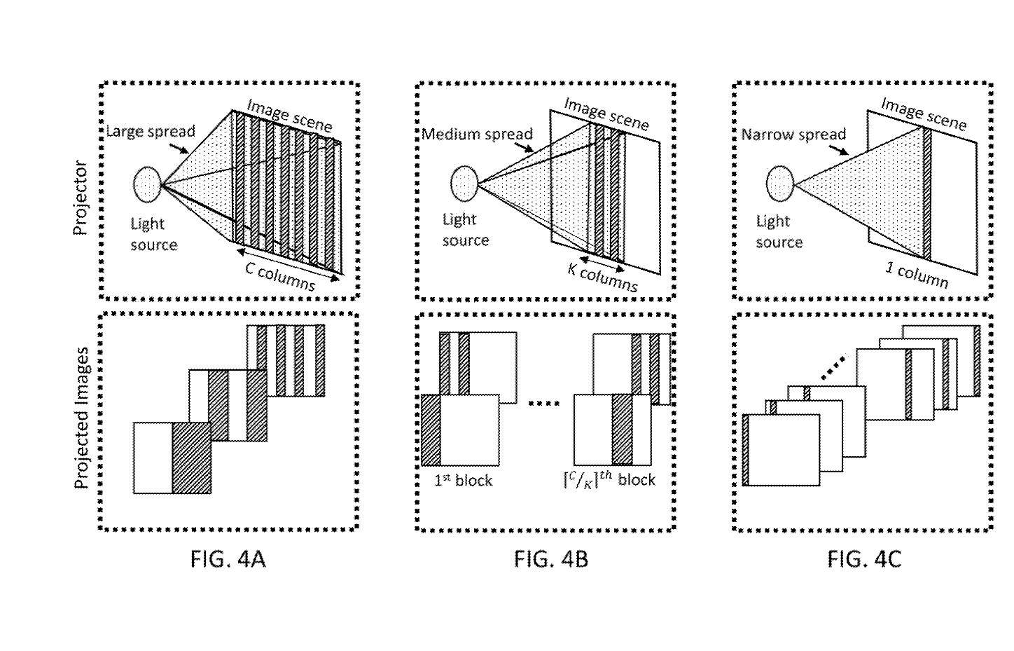

As shown in FIGS. 4A, 4B, and 4C, in accordance with some embodiments, mechanisms for generating structured light that are subject to a variety of ambient illumination levels can be used to measure the shapes of objects, in accordance with some embodiments. In particular, FIG. 4A shows mechanisms that can generate structured light, in a column pattern that includes C columns, projected over a projector image scene. As a result, a single column can have an intensity of

$$\frac{1}{C}$$

and the system can use N_{C} images to encode each column uniquely for a specific coding illumination pattern. Also, FIG. 4B, shows mechanisms that can generate structured light in a block pattern that includes K columns, wherein K is less than C, projected over a portion of the image scene. As a result, a single column can receive

$$\frac{K}{C}$$

more light than the previous projection distributed over the entire image scene and can use

$${N}_{K} \times \frac{C}{K}$$

images to encode each column uniquely for a specific coding illumination pattern. FIG. 4C shows mechanisms that can generate structured light in a single column pattern. As a result, the single column can have an intensity of 1 and can use N_{I}=C images to encode each column uniquely.

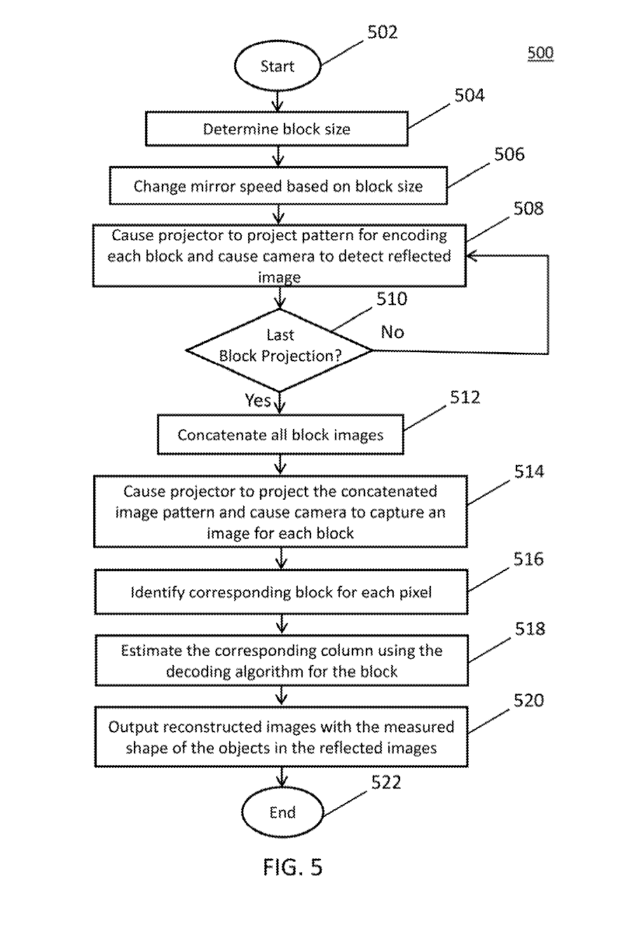

Turning to FIG. 5, an example 500 of a process for generating structured light in accordance with some embodiments is illustrated. This process can be performed in computer 102 of FIG. 1 in some embodiments.

As shown, after process 500 has begun at 502, the process can determine at 504 the size Kₒₚₜ of light pattern blocks to be projected onto the image scene. Each block can be non-overlapping and can have a size of Kₒₚₜ columns whereby Kₒₚₜ is a subset of the total number of columns C that the projector uses on the image scene. As a result, the total number of blocks needed to cover an image scene can be found by dividing the total number of columns C by the determined block size.

For example, in some embodiments, selecting the block size Kₒₚₜ can depend on satisfying a decodability condition:

$$\frac{{R}_{l}}{\sqrt{{R}_{a}}} \geq \frac{τ}{λ} ,$$

where the factors Rₗ and Rₐ are signal levels and are proportional to the intensities Iₗ and Iₐ corresponding to the light source and ambient illumination, respectively, τ is a threshold that the signal-to-noise ratio (SNR) should exceed, and λ is a constant. The light source signal level when the power is concentrated in K columns is

$${R}_{l} \frac{C}{K}$$

and, thus the block size can be determined using the following formula:

$${K}_{opt} = \frac{λ C}{τ} \frac{{R}_{l}}{\sqrt{{R}_{a}}}$$

A block of size K can be encoded using N_{K} images. The number of images depends on the type of encoding used for each block. Any suitable encoding can be used to create any suitable image patterns in some embodiments. For example, binary encoding (e.g., that uses binary Gray codes to create binary Gray coded patterns), sinusoidal phase-shifted encoding, G-ary color encoding, deBruijn single-shot encoding, and/or random dots projection encoding can be used in some embodiments.

When using binary Gray encoding, for example, the projected light patterns can only take a 0 or 1 values and the number of images required to encode each block can be N_{K}=log₂ K.

As another example, when using G-ary encoding, the projected light patterns can take G different values ranging from 1 to G and require N_{K}=log_{G} K images to encode each block.

As yet another example, when using sinusoidal phase-shifting encoding, the coding illumination patterns can be sinusoids and the number of images required to encode each block can be N_{K}=3.

As shown in FIG. 4B, the number of measurements required for generating structured light and subsequently reconstructing the image scene can be the product of N_{K} and the number of blocks

$$\frac{C}{K} .$$

When using a mock size of Kₒₚₜ, me number of measurements can be proportional to the signal level of ambient light and therefore the acquisition time for the system can depend on the ambient illumination levels.

Next, at 506, computer 102 of FIG. 1 can control the motor and therefore the rotational speed of the polygonal mirror used by projector 104. In accordance with some embodiments, the rotation speed used by the projector and the frame rate of the camera can be set at S scans per second and S frames per second, respectively. Computer 102 can then change the rotation speed by reducing it to

$$\frac{S \cdot K}{C}$$

scans per second.

Next, at 508, process 500 can cause the projector to project encoded light patterns on each block in some embodiments.

While the projector is projecting the encoding patterns on an image block, at 508, process 500 can also cause the camera to detect the projected pattern as reflected off the scene at 508.

Process 500 can then determine based on the number of non-overlapping blocks whether the projection just made at 508 is the last projection at 510. If not, process 500 can loop back to 508. Otherwise, process 500 can proceed to 512 to concatenate, for every i, all of the projected images

$$\{ {T}_{i}^{j} \vert 1 \leq i \leq {N}_{K} , 1 \leq j \leq \frac{C}{K} \}$$

into, a single concatenated image Tᵢ^{cat} that has C columns where the i and j are the image index within a block and the block index, respectively.

Then, at 514, process 500 can cause the projector to project Tᵢ^{cat} during a single projector scan.

While the projector is projecting the concatenated image, process 500 can also cause camera 106 to capture

$$\frac{C}{K}$$

images, one corresponding to each block. In some embodiments, captured images can be detected by camera 106 and stored in memory 204 as Iᵢ^{j}.

Next, at 516, process 500 can identify the block j that each pixel in each image Iᵢ^{j}, captured by camera 106, belongs to. In accordance with some embodiments, a camera pixel that belongs to a corresponding block j will receive light when that block in the projector is projecting light. As a result, the camera pixel will have an intensity value that will exceed some threshold for at least one of the images i captured by camera 106 that are related to the corresponding block j. Otherwise, the camera pixel will have intensity values that will not exceed the threshold for all images related to block j. The corresponding block for the camera pixel contains the corresponding column that was projected onto the scene as part of the illuminated coded patterns.

Process 500 can then estimate at 518 the unique intensity code of the corresponding column using the decoding algorithm that was used within the corresponding block identified in 516.

Process 500 can then generate and output at 520 a reconstructed image of the measured shapes of the objects that were captured in the reflected images.

Finally, process 500 can end at 522.

It should be understood that at least some of the above described steps of process 500 of FIG. 5 can be executed or performed in any order or sequence not limited to the order and sequence shown and described in the figure. Also, some of the above steps of process 500 of FIG. 5 can be executed or performed substantially simultaneously where appropriate or in parallel to reduce latency and processing times.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, and any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for generating structured light, comprising:
a light source that produces light;
a scanner that reflects the light onto a scene; and
a hardware processor that controls a scanning speed of the scanner, wherein the scanning speed of the scanner is controlled to provide variable light distributions.

2. The system of claim 1, wherein the light source is a laser light source.

3. The system of claim 1, wherein the light source projects a light pattern.

4. The system of claim 3, wherein the light pattern includes a block of columns.

5. The system of claim 3, wherein the light pattern is binary Gray coded.

6. The system of claim 1, wherein the variable light distributions are based on a size of a block of light, a camera frame rate, and a number of projector columns.

7. The system of claim 6, wherein the hardware processor determines the size of the block of light based on ambient illumination levels.

8. The system of claim 1, further comprising an image sensor coupled to the hardware processor that outputs signals corresponding to the detected light.

9. The system of claim 1, wherein the scanner comprises:
a polygonal mirror; and
a speed controllable motor coupled to the polygonal mirror, wherein the speed controllable motor causes the polygonal mirror to rotate at a rotation speed,
wherein the hardware processor controls rotation speed to control the scanning speed of the scanner

10. The system of claim 1, wherein the scanner comprises a galvanometer.

11. A method for generating structured light, comprising:
producing light using a light source;
reflecting the light onto a scene using a scanner; and
controlling a scanning speed of the scanner using a hardware processor, wherein the scanning speed of the scanner is controlled to provide variable light distributions.

12. The method of claim 11, wherein the light source is a laser light source.

13. The method of claim 11, wherein the light source projects a light pattern.

14. The method of claim 13, wherein the light pattern includes a block of columns.

15. The method of claim 13, wherein the light pattern is binary Gray coded.

16. The method of claim 11, wherein the variable light distributions are based on a size of a block of light, a camera frame rate, and a number of projector columns.

17. The method of claim 16, further comprising determining the size of the block of light based on ambient illumination levels.

18. The method of claim 11, further comprising outputting signals corresponding to the detected light using an image sensor coupled to the hardware processor.

19. The method of claim 11, wherein the scanner comprises:
a polygonal mirror; and
a speed controllable motor coupled to the polygonal mirror, wherein the speed controllable motor causes the polygonal mirror to rotate at a rotation speed,
wherein the hardware processor controls rotation speed to control the scanning speed of the scanner

20. The method of claim 11, wherein the scanner comprises a galvanometer.
